(19) United States
(12) Patent Application Publication
(10) Pub. No.: US 2020/0318794 A1
(43) Pub. Date: Oct. 8, 2020

(54) VALVE INTEGRATED PRESSURE REGULATOR (VIPR) FOR DISPENSING A GAS FROM A COMPRESSED GAS CYLINDER

(71) Applicants: Lloyd A. Brown, Amherst, NY (US); Kori Dunn, Grand Island, NY (US); Paul K. Oetinger, Gasport, NY (US)

(72) Inventors: Lloyd A. Brown, Amherst, NY (US); Kori Dunn, Grand Island, NY (US); Paul K. Oetinger, Gasport, NY (US)

(21) Appl. No.: 16/376,412

(22) Filed: Apr. 5, 2019

(51) Int. Cl. F17C 13/04; G05D 16/04; F16K 17/02; F17C 13/02

(52) U.S. Cl. CPC F17C 13/04; G05D 16/04; F16K 17/02; F17C 13/02; F17C 2205/0335; F17C 2205/0338; F17C 2205/0326; F17C 2250/0443; F17C 2205/0308; F17C 2201/0104

(57) ABSTRACT

A valve integrated pressure regulator (VIPR) assembly for dispensing a gas from a compressed gas cylinder is provided. The valve integrated pressure regulator (VIPR) includes a continuously adjustable, low pressure flow meter valve and a flow sensor incorporated directly into the valve body of the VIPR assembly.

### TECHNICAL FIELD

The present invention relates to a system and method for dispensing low pressure gas from a compressed gas cylinder, and more particularly, to a valve integrated pressure regulator (VIPR) based gas cylinder package that provides a continuously adjustable, low pressure flow control mechanism and a flow sensor incorporated directly into the valve body of the VIPR assembly.

### BACKGROUND

Conventional methods of providing a low pressure gas flow from a high pressure compressed gas cylinder typically require specially designed gas cylinder packages that include one of three configurations.

The first conventional configuration involves a high pressure valve coupled to the compressed gas cylinder and a separate, external pressure regulator which reduces the gas pressure to the desired range wherein the resulting low pressure gas is directed to an external flow controlling device, such as a flow meter, which allows the gas flow to be adjusted in a continuous manner to the desired gas flow setting.

The second conventional configuration employs a valve integrated pressure regulator (VIPR) device equipped with a pressure regulated gas outlet (which can be set to discharge at a low pressure) at a fixed gas flow rate. This fixed flow VIPR device is coupled or connected to an external flow controlling device, such as a flow meter, which allows the low pressure gas flow to be adjusted in a continuous manner to the desired gas flow setting.

The third conventional configuration also employs a VIPR device which is designed to provide a pressure regulated flow at two or more discrete gas flow settings. Such plurality of discrete gas flow settings in such VIPR based cylinder packages, may or may not be the desired gas flow setting for the intended application. Thus, to provide a continuously adjustable, low pressure gas flow, such discrete flow VIPR cylinder packages would be also coupled to an external device, such as a gas delivery device or flow meter which allows for the discrete gas flows to be further adjusted continuously over the desired range.

Examples of the valve/regulator based cylinder packages can be seen in the following prior art references: U.S. Pat. No. 4,655,246 which describes a compact valve for a gas cylinder with pressure regulation and flow control using calibrated orifices; U.S. Pat. No. 7,237,570 which describes a valve integrated pressure regulator with flow control achieved using calibrated orifices; and U.S. Pat. No. 9,126,281 which incorporates a flowmeter into the valve guard assembly. See also, United States Patent Application Publication Nos. 2016/0258540 which describes a valve/regulator assembly with discrete flow control settings integrated into the valve body using a series of calibrated orifices; and 2016/0341364 which contemplates use of an orifice plate or a proportional valve within the valve body, but does not disclose or teach incorporation of a flow sensor into the valve body.

All three conventional arrangements require connection of the gas outlet of the gas cylinder package to an external flow control device in order to achieve a continuously adjustable, low pressure flow to the user or the intended application. The connection and use of such multiple devices requires additional set-up time and potentially additional inventory of equipment prior to such use.

What is needed, therefore is a simple-to-use VIPR assembly or device suitable for use with high pressure compressed gas cylinders and that provides a continuously adjustable, low pressure flow control mechanism and a flow sensor incorporated directly into the valve body of the VIPR assembly or device.

### SUMMARY OF THE INVENTION

The present invention may be characterized as a gas cylinder dispensing valve configured as a valve integrated pressure regulator (VIPR) that includes a continuously adjustable, low pressure flow meter valve and a flow sensor incorporated directly into the valve body of the VIPR assembly. Specifically, the gas cylinder dispensing valve comprises: (i) a valve body; (ii) a pressure regulator attached to the valve body and configured to regulate gas pressure a the gas flow to a prescribed low pressure; (iii) an isolation valve positioned within the gas flow passageway between a gas inlet and the pressure regulator, the isolation valve having a valve stern configured to actuate the isolation valve between a closed position and an open position; (iv) a first knob operatively coupled to the valve stem of the isolation valve and configured to move the isolation valve between the closed position and the open position; (v) a continuous, proportional metering valve disposed within the valve body and positioned within the gas flow passageway downstream of the pressure regulator and configured to control the flow of the gas to the gas outlet; (vi) a second knob operatively operatively coupled to the metering valve and configured to adjust the movement of the metering valve and thereby adjust the flow of gas to the gas outlet; (vii) a flow sensor disposed between the metering valve and a gas outlet, the flow sensor configured to measure a flow rate of the gas between the metering valve and the gas outlet; and (viii) a controller coupled to the valve body and configured to receive a flow rate signal from the flow sensor indicative of the flow rate of the gas between the metering valve and the gas outlet and to generate and send one or more signals to an electronic display indicative of the measured flow rate to the gas outlet.

The present invention may also be characterized as a valve integrated pressure regulator based cylinder package comprising a compressed gas cylinder and a valve integrated pressure regulator assembly that incorporates a continuously adjustable, low pressure flow meter valve and a flow sensor. The valve integrated pressure regulator (VIPR) assembly comprises: (i) a valve body having a gas flow passageway through the valve body and further having an inlet and an outlet, wherein the inlet is configured to be removably coupled to the compressed gas cylinder and to receive gas from the compressed gas cylinder; (ii) a pressure regulator attached to the valve body and configured to regulate gas pressure of the gas flow to a fixed low pressure; (iii) an isolation valve disposed within the valve body, the isolation valve configured for controllably closing or opening the gas flow passageway to the flow of gas therethrough; (iv) a manually operable first knob attached to the exterior of the valve body and operatively connected to the isolation valve to impart motion to the isolation valve to move the isolation valve between a dosed position and an open position; (v) a continuous, proportional metering valve disposed within the valve body and positioned within the gas flow passageway downstream of the pressure regulator and configured to control the flow of the gas to the gas outlet; (vi) a second knob operatively coupled to the metering valve and configured to adjust the movement of the metering valve and thereby adjust the flow of gas to the gas outlet; (vii) a flow sensor disposed between the metering valve and a gas outlet, the flow sensor configured to measure a flow rate of the gas between the metering valve and the gas outlet; and (viii) a controller coupled to the valve body and configured to receive a flow rate signal from the flow sensor indicative of the flow rate of the gas between the metering valve and the gas outlet and to generate and send one or more signals to an electronic display indicative of the measured flow rate to the gas outlet.

Preferred embodiments of the gas cylinder dispensing valve and valve integrated pressure regulator assembly may also include a high pressure relief valve fluidically coupled to the gas flow passageway upstream of the isolation valve and/or a low pressure relief valve fluidically coupled to the gas flow passageway downstream of the metering valve. In addition, a pressure gauge coupled to the valve body is configured to measure the pressure in the gas flow passageway upstream of the isolation valve which is indicative of the pressure within the compressed gas cylinder.

In selected embodiments of the of the gas cylinder dispensing valve and valve integrated pressure regulator assembly further include a battery powered electronic display operatively coupled to the controller, wherein the controller is configured to generates and sends one or more signals to the electronic display indicative various operating conditions. The electronic display may be attached directly to the valve body or alternatively separated from the valve body and connected via one or more wires to the controller or via a wireless connection to the controller.

Examples of the various operating conditions monitored by the controller and displayed on the electronic display may include the measured pressure within the compressed gas cylinder and/or the measured flow rate of the gas in the gas flow passageway between the metering valve and the gas outlet. The controller may also be configured to calculate the total flow of gas from the cylinder and/or the time remaining until the compressed gas cylinder is empty or at a near-empty condition based on the measured flow rate and the measured pressure, displaying such calculated values on the electronic display. The controller may also be configured to determine a basic flow indicator status indicating whether there is an active gas flow to the gas outlet or there is no gas flow to the outlet.

### BRIEF DESCRIPTION OF THE DRAWINGS

While the specification concludes with one or more claims specifically pointing out the subject matter that Applicants' regard as the invention, it is believed that the claims will be better understood when taken in connection with the accompanying drawing in which:

FIG. 1 is a perspective view of an embodiment of the present valve integrated pressure regulator depicting the location and arrangement of a gas outlet, a controller, a pressure gauge, and flow control knobs;

FIG. 2 is yet another perspective view of the valve integrated pressure regulator of FIG. 1 further depicting the location of a pressure relief valve, a fill adapter, and the pressure regulator;

FIG. 3 is a side view of the valve integrated pressure regulator of FIG. 1;

FIG. 4 is a cross-section view of the valve integrated pressure regulator of FIG. 3 taken along line 4-4;

FIG. 5 is a cross-section view of the valve integrated pressure regulator of FIG. 3 taken along line 5-5;

FIG. 6 is a front view of the valve integrated pressure regulator of FIG. 1;

FIG. 7 is a cross-section view of the valve integrated pressure regulator of FIG. 6 taken along line 7-7;

FIG. 8 is a perspective view of an alternate embodiment of the valve integrated pressure regulator;

FIG. 9 is yet another perspective view of the valve integrated pressure regulator of FIG. 8;

FIG. 10 is a side view of the valve integrated pressure regulator of FIG. 8;

FIG. 11 is a cross-section view of the valve integrated pressure regulator of FIG. 10 taken along line A-A;

FIG. 12 is a cross-section view of the valve integrated pressure regulator of FIG. 10 taken along line B-B;

FIG. 13 is a front view of the alternate embodiment of the valve integrated pressure regulator; and

FIG. 14 is a cross-section view of the valve integrated pressure regulator of FIG. 13 taken along line C-C.

### DETAILED DESCRIPTION

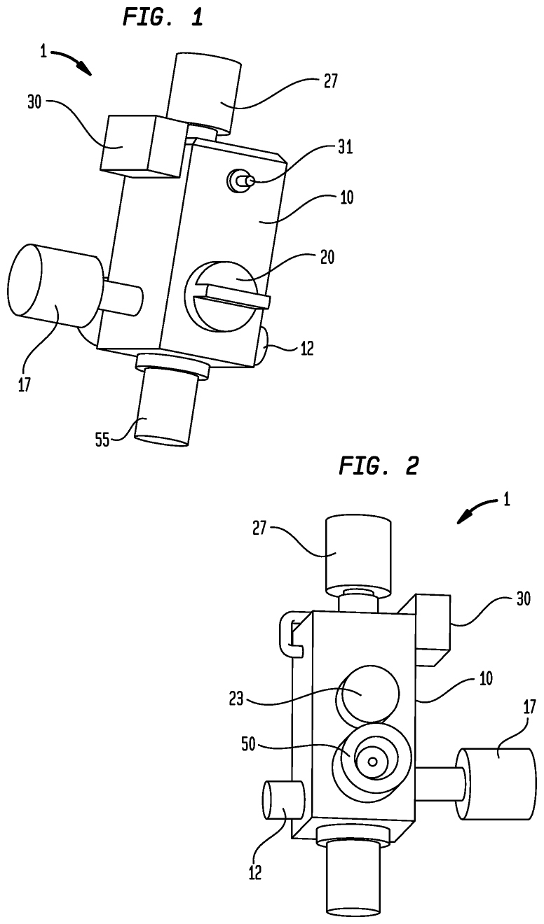

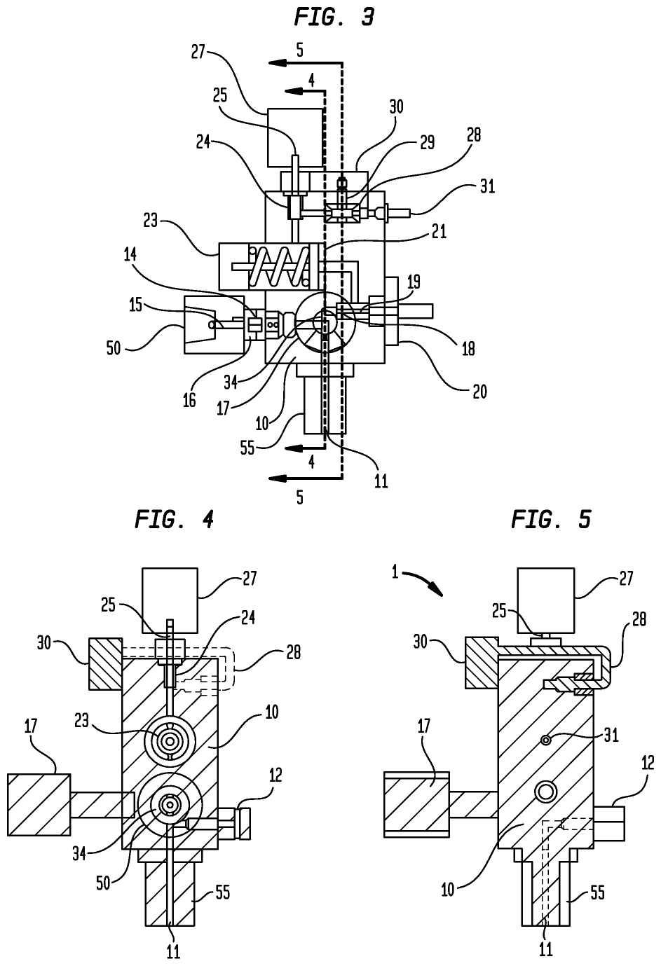

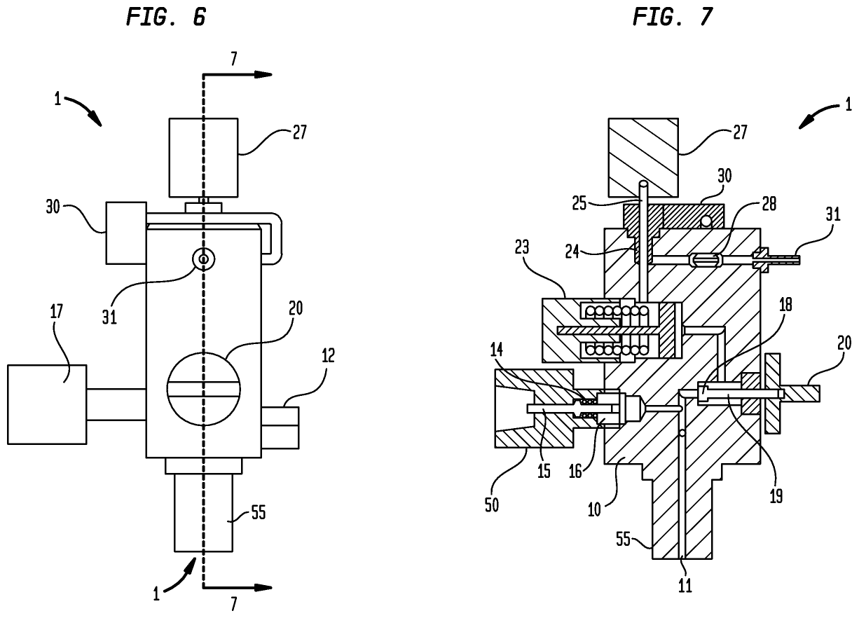

Turning now to FIGS. 1-7 of the drawings, an embodiment of the present valve integrated pressure regulator (VIPR) assembly 1 is shown. When mounted or attached to a compressed gas cylinder and optionally covered or shrouded with a valve guard, the illustrated VIPR assembly forms a valve integrated pressure regulator based cylinder package. Advantageously, the VIPR assembly 1 integrates a continuous, low pressure, flow control mechanism (i.e. metering valve) and flow sensing element (e.g. flow sensor or flow meter) directly into the valve body of a valve integrated pressure regulator, and more specifically at a location in the gas flow passageway downstream of the integrated pressure regulator and also downstream of one or more pressure relief valves or mechanisms.

The illustrated embodiment of the VIPR assembly 1 includes: a valve body 10; a cylinder connection 55, a high pressure relief valve 12; a gas fill port 50; a pressure gauge 17; a first on-off knob 20 configured to open or close an isolation valve 34; a pressure regulator 23; a second continuously adjustable knob 27 configured to adjust a metering valve 24; a flow sensor 28, a controller 30; and a gas outlet 31.

The valve body 10 includes a cylinder connection 55 with a gas inlet 11 that is configured to couple or otherwise connect with an open head portion of a compressed gas cylinder. Within the valve body 10 there is a gas flow passageway for dispensing the compressed gas from the gas inlet 11 via the isolation valve 34, pressure regulator 23, and the metering valve 24 to the gas outlet 31.

The isolation valve 34 is disposed within the valve body 10, and more particularly, along the gas flow passageway between the gas inlet 11 and the pressure regulator 23. The isolation valve 34 is configured to open or close the gas flow passageway in response to movement of the first on-off knob 20. The first on-off knob 20 is preferably a rotatable knob movable from a first position that places the isolation valve 34 in the closed position to a second position that places the isolation valve 34 in the open position allowing gas flow through the gas flow passageway from the compressed gas cylinder via the gas inlet 11 to the pressure regulator 23. When isolation valve 34 is in the closed position, there is no gas flow to the pressure regulator 23. The isolation valve 34 includes a valve seat 18 and a valve stem 19 that is actuated or moved between the closed position and the open position by turning the first on-off knob 20. Although an isolation valve is preferred, it is contemplated that other valves are suitable for use with the VIPR assembly and can be substituted for the isolation valve.

Also disposed within valve body 10 is a gas fill port 50 configured for filling the compressed gas cylinder from an external source. Check valve 14 is associated with and in fluid communication with the gas fill port 50 and to the gas flow passageway upstream of isolation valve 34. Check valve 14 includes a check valve pin 15 and check valve retainer 16 and is configured to allow gas flow from the external source via gas fill port 50 to the compressed gas cylinder via cylinder connection 55.

A pressure regulator 23 is also incorporated into the valve body 10 along the gas flow passageway and disposed downstream of the isolation valve 34. The pressure regulator 23 is configured to regulate the pressure of a flow of the gas within the gas flow passageway to a prescribed or predetermined low pressure. A pressure regulator cap is preferably placed over the exposed end of the pressure regulator 23 extending from the valve body 10 to prevent damage thereto or unintended adjustment of the pressure regulator.

The illustrated VIPR assembly 1 also includes a continuous, proportional metering valve 24 disposed within the valve body 10 and positioned within the gas flow passageway downstream of the pressure regulator 23. The metering valve 24 includes a control stem 25 projecting from the valve body 10 that is configured to adjust the movement of the metering valve 24 thereby controlling the flow of the gas to the gas outlet 31. The control stem 25 is actuated by rotating or turning a lockable second rotatable knob 27 from a first position that places the metering valve 24 in a closed position to a series or plurality of open positions that adjusts or modulates the gas flow to the gas outlet 31 when the isolation valve 34 is also open. In other words, the second knob 27 is operatively coupled to the control stem 25 of the metering valve 24 and configured to adjust the movement of the metering valve 24 and thereby adjust the flow of gas to the gas outlet 31 in response to the rotational movement of the second knob 27. The second knob is preferably lockable such that the selected flow rate may be maintained, and further adjustment of the flow rate would require specific unlocking action by the user.

A flow sensor 28 or flow meter is disposed in the gas flow passageway downstream of the metering valve 24 and upstream of the gas outlet 31. The flow sensor 28 is preferably configured to measure the flow rate of the gas delivered to the gas outlet 31. The flow sensor 28 is configured to produce a flow rate signal indicative of the flow rate of the gas in the gas flow passageway between the metering valve 24 and the gas outlet 31. The flow sensor 28 or flow meter is operatively coupled to the controller 30 and/or the electronic display such that the flow rate signal can be sent to the controller 30 which in turn generates and sends one or more signals indicative of the measured flow rate of the gas to the electronic display. In preferred embodiments, the electronic display is either attached directly to the valve body 10 or component of the VIPR assembly 1 or alternatively separated from the VIPR assembly 1 and connected to the controller via one or more wires or by means of a wireless communication protocol.

In some embodiments, the controller is optionally configured to determine a flow indicator status indicating whether there is an active gas flow to the gas outlet or there is no gas flow to the gas outlet, based on the measurements of the flow sensor or internal flow meter. Such flow indicator status is likewise represented by one or more display signals sent from the controller to the electronic display that may be further configured to display a visual indication of an active gas flow to the gas outlet or a visual indication that there is no gas flow to the gas outlet. In other embodiments, the controller may also be configured to calculate the time remaining until the compressed gas cylinder is empty or at a near-empty condition based on the measured flow rate of the gas in the gas flow passageway between the metering valve and the gas outlet and the measured pressure within the compressed gas cylinder. The controller may further be configured to monitor the total flow of gas has occurred from the cylinder.

The controller and electronic display may optionally include one or more visual or audible alarms or alerts to notify the user of certain conditions of the gas cylinder, VIPR assembly or uses thereof. Examples of selected alarm or alert conditions may include selected failure modes, gas cylinder empty or near empty condition, excessive pressures and/or temperatures, possible leaks, hazardous environments, VIPR assembly in locked or unlocked condition, etc.

In addition, a battery is also preferably incorporated within the VIPR assembly to provide the requisite power to the electronic display and controller. The battery is preferably attached to or otherwise coupled to the controller. Alternatively, the battery may be optionally contained within a valve guard and coupled via a wired connection to the controller. Such valve guards are well known in the art and often used to provide protection of the VIPR assembly or selected components thereof from damage during transportation, handling and use of the VIPR cylinder package and VIPR assembly. For example, a valve guard may be configured to shroud or cover the top portion of the VIPR assembly encompassing the metering valve, the flow sensor, the controller and the electronic display. Alternatively, a valve guard may be configured to shroud or cover the entire VIPR assembly while allowing visual and/or tactile access to the various knobs, fill port, pressure gauge, and electronic display.

The VIPR assembly also preferably includes a pressure gauge 17 coupled to the valve body 10 and configured to measure the pressure in the gas flow passageway upstream of the isolation valve 34 which is indicative of the pressure of the compressed gas within the compressed gas cylinder. The pressure gauge 17 may be an analog pressure gauge or a digital pressure gauge and may be operatively coupled to the controller 30 and/or electronic display for added functionality. Examples of additional functionality related to pressure measurements of the compressed gas cylinder would include gas flow totalization, determination of time remaining until the compressed gas cylinder is empty or in a near-empty condition. The pressure gauge 17 may also be configured to provide visual or audible alarms and warnings, as well as support wireless communication features for tracking and monitoring the compressed gas cylinders.

Lastly, one or more pressure relief valves fluidically coupled to the gas flow passageway are preferably integrated into the valve body 10 of VIPR assembly 1. In the embodiment shown in FIGS. 1-7, the pressure relief valve 12 is a high pressure relief valve disposed upstream of the pressure regulator 23 and the metering valve 24, and preferably proximate to the isolation valve 34.

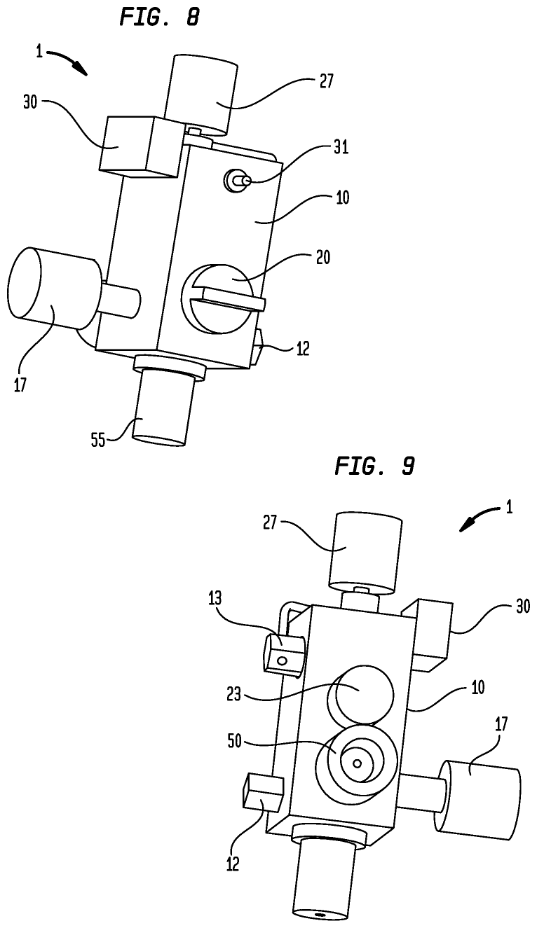

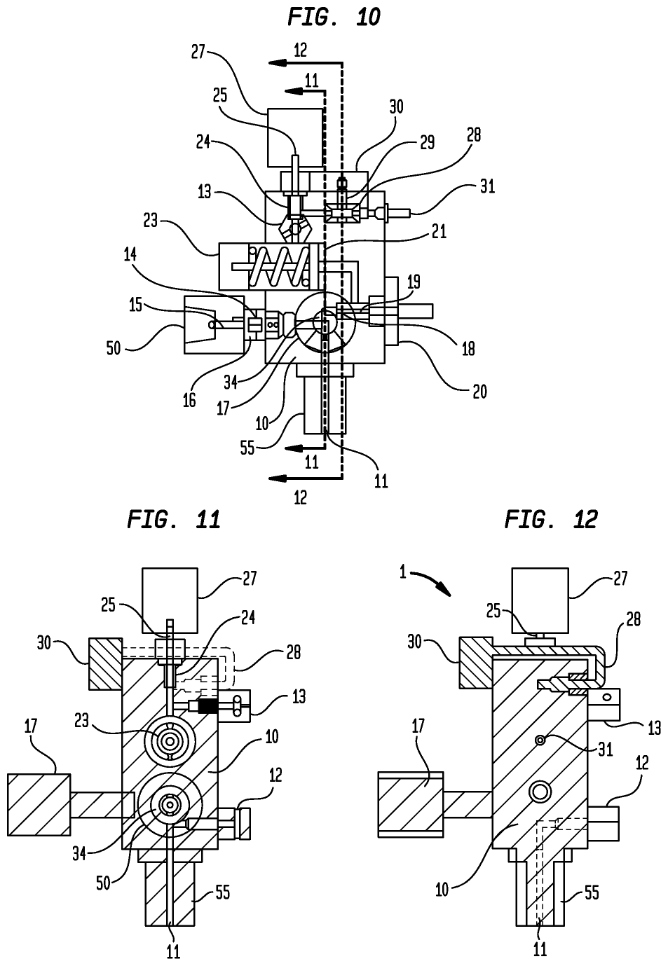

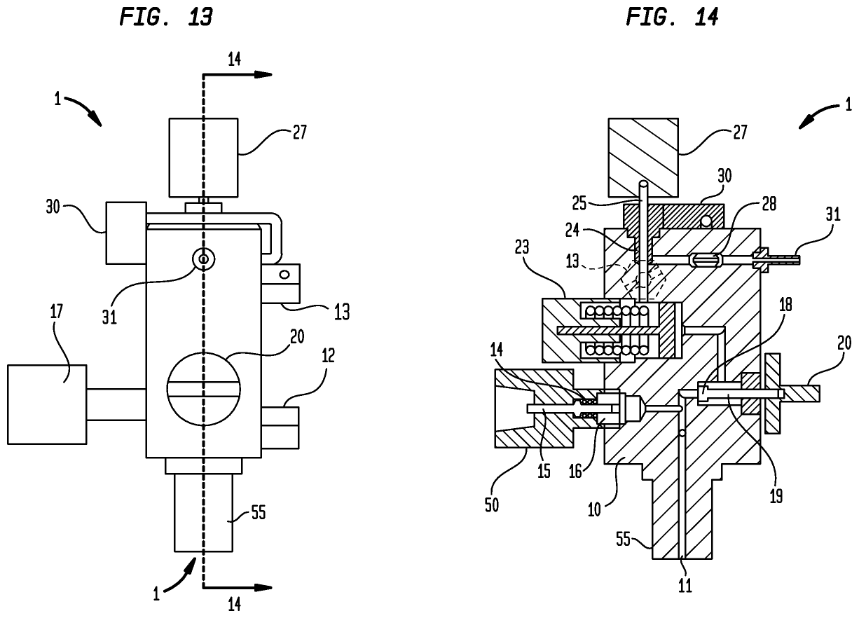

In the embodiment shown in FIGS. 8-14, the VIPR assembly 1 includes a first high pressure relief valve 12 disposed upstream of the pressure regulator 23 and the metering valve 24, and preferably proximate to the isolation valve 34 as well as a low pressure relief valve 13 fluidically coupled to the gas flow passageway at a location between the pressure regulator 23 and the metering valve 24. All other components and elements of the VIPR assembly shown in FIGS. 8-14 are similar to or identical to the corresponding components shown and described with reference to FIGS. 1-7 and for the sake of brevity will not be repeated.

While the present invention has been described with reference to a preferred embodiment or embodiments, it is understood that numerous additions, changes and omissions can be made without departing from the spirit and scope of the present invention as set forth in the appended claims.

What is claimed is:

1. A gas cylinder dispensing valve for dispensing a gas from a compressed gas cylinder comprising:
a valve body configured to couple to a compressed gas cylinder and having a gas flow passageway communicating between a gas inlet and a gas outlet;
a pressure regulator attached to the valve body and configured to regulate gas pressure of a flow of the gas within the gas flow passageway to a prescribed low pressure;
an isolation valve positioned within the gas flow passageway, between the gas inlet and the pressure regulator, the isolation valve having a valve stem configured to actuate the isolation valve between a closed position and an open position;
a first knob operatively coupled to the valve stem of the isolation valve, the first knob configured to impart motion to the isolation valve to move the isolation valve between the closed position and the open position;
a continuous, proportional metering valve disposed within the valve body and positioned within the gas flow passageway downstream of the pressure regulator, the metering valve having a control stem projecting from the valve body to adjust the movement of the metering valve to control the flow of the gas to the gas outlet;
a second knob operatively coupled to the control stem of the metering valve and configured to adjust the movement of the metering valve and thereby adjust the flow of gas to the gas outlet in response to movement of the second knob; and
a flow sensor disposed in the gas flow passageway between the metering valve and the gas outlet, the flow sensor configured to measure a flow rate of the gas in the gas flow passageway between the metering valve and the gas outlet.

2. The gas cylinder dispensing valve of claim 1 further comprising a controller coupled to the valve body and configured to receive a flow rate signal from the flow sensor indicative of the flow rate of the gas in the gas flow passageway between the metering valve and the gas outlet and to generate and send one or more signals to an electronic display indicative of the measured flow rate of the gas in the gas flow passageway between the metering valve and the gas outlet.

3. The gas cylinder dispensing valve of claim 1 wherein the second knob is a second rotatable knob movable from a first position that places the metering valve in a closed position preventing gas flow to the gas outlet to a plurality of alternate positions that places the metering valve in an open position allowing adjustment of the gas flow to the gas outlet when the isolation valve is open.

4. The gas cylinder dispensing valve of claim 1 further comprising a high pressure relief valve fluidically coupled to the gas flow passageway upstream of the isolation valve.

5. The gas cylinder dispensing valve of claim 1 further comprising a low pressure relief valve fluidically coupled to the gas flow passageway downstream of the metering valve.

6. The gas cylinder dispensing valve of claim 2 further comprising a pressure gauge coupled to the valve body and configured to measure the pressure in the gas flow passageway upstream of the isolation valve which is indicative of the pressure within the compressed gas cylinder.

7. The gas cylinder dispensing valve of claim 6 wherein the pressure gauge is operatively coupled to the controller and configured to send a pressure signal indicative of the pressure within the compressed gas cylinder to the controller, and wherein the controller generates and sends one or more signals to the electronic display indicative of the measured pressure within the compressed gas cylinder.

8. The gas cylinder dispensing valve of claim 7 wherein the controller is configured to calculate the time remaining until the compressed gas cylinder is empty or at a near-empty condition based on the measured flow rate of the gas in the gas flow passageway between the metering valve and the gas outlet and the measured pressure within the compressed gas cylinder.

9. The gas cylinder dispensing valve of claim 7 wherein the controller is configured to calculate the total flow of gas from the cylinder.

10. The gas cylinder dispensing valve of claim 2 wherein the controller is further configured to determine a flow indicator status indicating whether there is an active gas flow to the gas outlet or there is no gas flow to the outlet, and wherein the controller generates and sends one or more display signals to the electronic display indicative of the determined flow indicator status and, wherein the electronic display is configured to display a visual indication of gas flow to the gas outlet or no gas flow to the gas outlet.

11. The gas cylinder dispensing valve of claim 1 wherein the first knob is a first rotatable knob movable from a first position that places the isolation valve in the closed position preventing gas flow through the gas flow passageway to the gas outlet to a second position that places the isolation valve in the open position allowing flow from the compressed gas cylinder through the gas flow passageway to the gas outlet.

12. The gas cylinder dispensing valve of claim 2 wherein the electronic display is attached to the valve body.

13. The gas cylinder dispensing valve of claim 2 wherein the electronic display is separated from the valve body and connected via one or more wires to the controller.

14. The gas cylinder dispensing valve of claim 2 wherein the electronic display is separated from the valve body and communicates with the controller via wireless communication protocol.

15. The gas cylinder dispensing valve of claim 2 further comprising a battery configured to provide power to the electronic display and controller, and wherein the battery is mounted on the controller.

16. The gas cylinder dispensing valve of claim 2 further comprising a valve guard configured to encompassing the metering valve, the controller and the electronic display

17. The gas cylinder dispensing valve of claim 16 further comprising a battery configured to provide power to the electronic display and controller, and wherein the battery is contained within the valve guard.

18. A valve integrated pressure regulator based cylinder package comprising:
a compressed gas cylinder;
a valve integrated pressure regulator assembly, the valve integrated pressure regulator assembly having a valve body and a gas flow passageway through the valve body, the valve body further having an inlet and an outlet, wherein the inlet is configured to be removably coupled to the compressed gas cylinder and to receive gas from the compressed gas cylinder;
the valve integrated pressure regulator assembly further comprising an isolation valve disposed within the valve body, the isolation valve configured for controllably closing or opening the gas flow passageway to the flow of gas therethrough, and a manually operable first knob attached to the exterior of the valve body and operatively connected to the isolation valve to impart motion to the isolation valve to move the isolation valve between a closed position and an open position by movement of the first knob;
the valve integrated pressure regulator assembly further comprising a pressure regulator attached to the valve body and configured to regulate the gas pressure of any gas flow within the gas flow passageway to a fixed low pressure;
the valve integrated pressure regulator assembly further comprising a continuous, proportional metering valve disposed within the valve body and positioned within the gas flow passageway downstream of the pressure regulator, the metering valve having a control stem projecting from the valve body to adjust the movement of the metering valve to control the flow of the gas through the gas flow passageway to the gas outlet and a second knob operatively coupled to the control stem of the metering valve and configured to adjust the movement of the metering valve and thereby adjust the flow of gas through the gas flow passageway to the gas outlet in response to movement of the second knob; and
the valve integrated pressure regulator assembly further comprising a flow sensor disposed within the valve body in the gas flow passageway between the metering valve and the gas outlet, the flow sensor configured to measure a flow rate of the gas in the gas flow passageway between the metering valve and the gas outlet.

19. The valve integrated pressure regulator based cylinder package of claim 18 further comprising a controller configured to receive a flow rate signal from the flow sensor indicative of the flow rate of the gas in the gas flow passageway between the metering valve and the gas outlet and to send one or more signals to an electronic display indicative of the measured flow rate of the gas in the gas flow passageway between the metering valve and the gas outlet.

20. The valve integrated pressure regulator based cylinder package of claim 18 wherein the second knob is a second rotatable knob movable from a first position that places the metering valve in a closed position preventing gas flow to the gas outlet to a plurality of alternate positions that places the metering valve in an open position allowing adjustment of the gas flow to the gas outlet when the isolation valve is open.

21. The valve integrated pressure regulator based cylinder package of claim 18 further comprising a high pressure relief valve fluidically coupled to the gas flow passageway upstream of the isolation valve.

22. The valve integrated pressure regulator based cylinder package of claim 18 further comprising a low pressure relief valve fluidically coupled to the gas flow passageway downstream of the regulator and upstream of the metering valve.

23. The valve integrated pressure regulator based cylinder package of claim 19 further comprising a pressure gauge coupled to the valve body and configured to measure the pressure in the gas flow passageway upstream of the isolation valve which is indicative of the pressure within the compressed gas cylinder.

24. The valve integrated pressure regulator based cylinder package of claim 23 wherein the pressure gauge is operatively coupled to the controller and configured to send a pressure signal indicative of the pressure within the compressed gas cylinder to the controller, and wherein the controller generates and sends one or more signals to the electronic display indicative of the measured pressure within the compressed gas cylinder.

25. The valve integrated pressure regulator based cylinder package of claim 24 wherein the controller is configured to calculate the time remaining until the compressed gas cylinder is empty or at a near-empty condition based on the measured flow rate of the gas in the gas flow passageway between the metering valve and the gas outlet and the measured pressure within the compressed gas cylinder.

26. The valve integrated pressure regulator based cylinder package of claim 19 wherein the controller is further configured to determine a flow indicator status indicating whether there is an active gas flow to the gas outlet or there is no gas flow to the outlet, and wherein the controller generates and sends one or more display signals to the electronic display indicative of the determined flow indicator status and, wherein the electronic display is configured to display a visual indication of gas flow to the gas outlet or no gas flow to the gas outlet.

27. The valve integrated pressure regulator based cylinder package of claim 19 wherein the controller is configured to calculate the total flow of gas from the cylinder.

28. The valve integrated pressure regulator based cylinder package of claim 19 wherein the first knob is a first rotatable knob movable from a first position that places the isolation valve in the closed position preventing gas flow through the gas flow passageway to the gas outlet to a second position that places the isolation valve in the open position allowing flow from the compressed gas cylinder through the gas flow passageway to the gas outlet.

29. The valve integrated pressure regulator based cylinder package of claim 19 wherein the electronic display is attached to the valve body and the electronic display capable of displaying information in digital form or analog form.

30. The valve integrated pressure regulator based cylinder package of claim 19 wherein the electronic display is separated from the valve body and connected via one or more wires to the controller.

31. The valve integrated pressure regulator based cylinder package of claim 19 wherein the electronic display is separated from the valve body and communicates with the controller via wireless communication protocol.

32. The valve integrated pressure regulator based cylinder package of claim 19 further comprising a battery configured to provide power to the electronic display and the controller, and wherein the battery is mounted on the controller.

33. The valve integrated pressure regulator based cylinder package of claim 19 further comprising a valve guard configured to encompass the isolation valve, the pressure regulator, the metering valve, the controller and the electronic display.

34. The valve integrated pressure regulator based cylinder package of claim 19 further comprising a battery configured to provide power to the electronic display and the controller, and wherein the electronic display, the controller, and the battery are attached to or contained within a valve guard.
